(19) United States
(12) Patent Application Publication
(10) Pub. No.: US 2004/0051466 A1
(43) Pub. Date: Mar. 18, 2004

(54) Lighting apparatus capable of providing auxiliary and emergency illumination

(76) Inventor: Chang-Ming Liu, Taichung City (TW)

Correspondence Address: TROP PRUNER & HU, PC, 8554 KATY FREEWAY, SUITE 100, HOUSTON, TX, 77024, US

(21) Appl. No.: 10/242,133

(22) Filed: Sep. 12, 2002

(51) Int. Cl. H05B 41/36

(52) U.S. Cl. 315/149; 315/291

(57) ABSTRACT

A lighting apparatus includes a primary power supply, a primary lighting unit, a control unit, a secondary lighting unit, a light sensor, and a back-up power supply. The control unit is connected to the primary power supply, the primary lighting unit, the secondary lighting unit, the light sensor and the back-up power supply. The primary lighting unit includes at least one high-power lamp controlled by the control unit. The secondary lighting unit includes at least one low-power high-intensity light source. The light sensor generates a light signal corresponding to intensity of ambient light. The control unit enables operation of the secondary lighting unit when the primary lighting unit is deactivated during poor ambient light conditions, and further enables supply of power from the back-up power supply to the secondary lighting unit to activate the latter when power failure of the primary power supply occurs.

### BACKGROUND OF THE INVENTION

1. Field of the Invention

The invention relates to a lighting apparatus, more particularly to a lighting apparatus capable of providing auxiliary and emergency illumination.

2. Description of the Related Art

Control of a conventional lighting apparatus is usually accomplished via manual control, with or without the use of a remote controller. As such, when it is desired to activate the lighting apparatus during poor ambient light conditions, inconveniences and accidents can arise in view of the need to locate the associated switch or remote controller.

Furthermore, a conventional lighting apparatus for household use usually does not provide emergency illumination in the event of power failure. As such, there is a need to install additional emergency illumination equipments.

### SUMMARY OF THE INVENTION

The main object of the present invention is to provide a lighting apparatus that can overcome the aforesaid drawbacks associated with the prior art.

Accordingly, a lighting apparatus of this invention comprises a primary power supply, a primary lighting unit, a control unit, a secondary lighting unit, a light sensor, and a back-up power supply.

The primary power supply is adapted to be connected electrically to an electrical outlet. The primary lighting unit is connected to the primary power supply and includes at least one high-power lamp. The control unit is connected to the primary power supply and the primary lighting unit, and is operable so as to control activation of the primary lighting unit. The secondary lighting unit is connected to the control unit, and includes at least one low-power high-intensity light source. The light sensor is connected to the control unit, and generates a light signal corresponding to intensity of ambient light. The back-up power supply is connected to the control unit. The control unit enables operation of the secondary lighting unit when the primary lighting unit is deactivated and the light signal from the light sensor indicates a poor ambient light condition. The control unit further enables supply of power from the back-up power supply to the secondary lighting unit to permit activation of the secondary lighting unit when power failure of the primary power supply occurs.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view showing a preferred embodiment of a lighting apparatus according to the present invention;

FIG. 2 is a schematic circuit block diagram of the preferred embodiment of a lighting apparatus according to the present invention; and

FIG. 3 is a schematic electrical circuit diagram of the preferred embodiment of a lighting apparatus according to the present invention.

### DETAILED DESCRIPTION OF THE PREFERRED EMBODIMENT

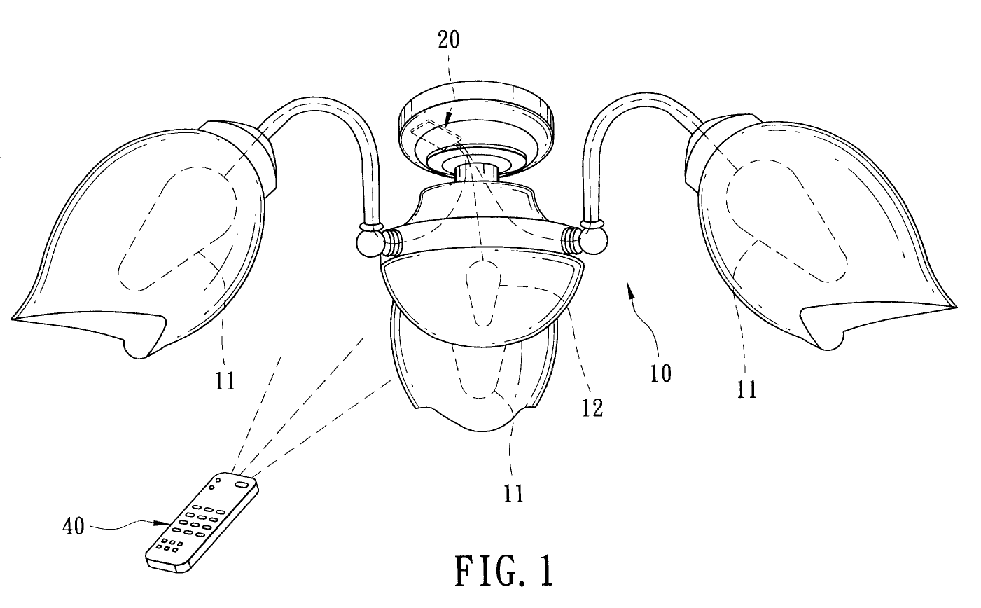

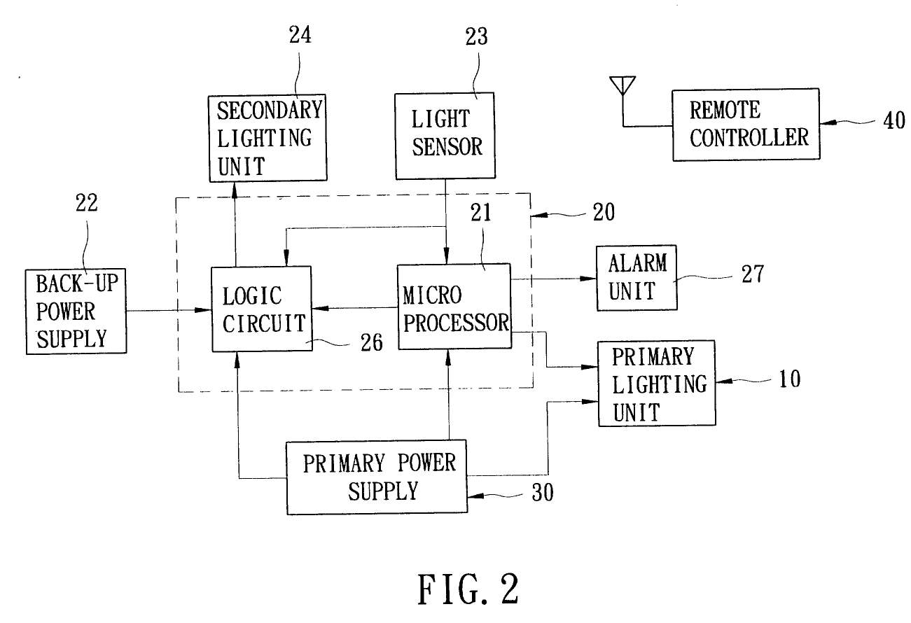

Referring to FIGS. 1 to 3, a lighting apparatus according to the present invention is shown to be embodied in a ceiling lamp that includes a primary power supply 30, a primary lighting unit 10, a control unit 20, a secondary lighting unit 24, a light sensor 23, a back-up power supply 22, a remote controller 40, and an alarm unit 27.

The primary power supply 30 is adapted to be connected electrically to an electrical outlet, and is operable so as to generate a DC voltage output (Vdc).

The primary lighting unit 10, which is conventional in construction, is connected to the primary power supply 30 and includes at least one high-power lamp. In this embodiment, the primary lighting unit 10 includes a number of light bulbs 11 and a night lamp 12.

The control unit 20 is connected to the primary power supply 30 and the primary lighting unit 10, and is operable so as to control activation of the primary lighting unit 10. The remote controller 40 is operably associated with the control unit 20 in a known manner to control operation of the control unit 20, such as turning on and off each component 11, 12 of the primary lighting unit 10. The control unit 20 includes a microprocessor 21 and a logic circuit 26 connected to the microprocessor 21. The microprocessor 21 is responsible for controlling activation of the primary lighting unit 10. The logic circuit 26 is responsible for controlling supply of power from one of the primary and back-up power supplies 30, 22 to the secondary lighting unit 24, which will be described in greater detail hereinafter.

The secondary lighting unit 24 is connected to the logic circuit 26 of the control unit 20, and includes at least one low-power high-intensity light source 241. In this embodiment, the secondary lighting unit 24 includes four light sources 241, each of which is a light emitting diode. The number of the light sources 241 may vary depending upon actual requirements.

The light sensor 23 includes a phototransistor 231, and is connected to both the microprocessor 21 and the logic circuit 26 of the control unit 20. The light sensor 23 generates a light signal corresponding to intensity of ambient light detected by the phototransistor 231 and sends the same to the control unit 20.

The back-up power supply 22 includes a rechargeable battery unit 222, a charging circuit 221, and a voltage step-up unit 25. The battery unit 222 is connected to the logic circuit 26 via the voltage step-up unit 25, which promotes the battery voltage to a level (Vbat) sufficient for driving the secondary lighting unit 24, such as +5 volts. The charging circuit 221 is connected to the battery unit 222, the primary power supply 30 and the microprocessor 21 of the control unit 20.

To minimize inconvenience when activating the primary lighting unit 10 under poor ambient light conditions, the microprocessor 21 and the logic circuit 26 of the control unit 20 cooperate to enable supply of power, i.e. the DC voltage output (Vdc), from the primary power supply 30 to the secondary lighting unit 24 for operating the secondary lighting unit 24 when the primary lighting unit 10 is deactivated, the light signal from the light sensor 23 indicates a poor ambient light condition, and power failure of the primary power supply 30 does not occur. When the primary lighting unit 10 is activated due to operation of the remote controller 40, the control unit 20 will deactivate the secondary lighting unit 24. Moreover, when power failure of the primary power supply 30 occurs, the logic circuit 26 enables supply of power from the back-up power supply 22 to the secondary lighting unit 24 to permit activation of the secondary lighting unit 24 during poor ambient light conditions.

To maintain the stored energy of the battery unit 222 at an appropriate level, the microprocessor 21 activates the charging circuit 221 to initiate charging of the battery unit 222 by the primary power supply 30 upon detection that the battery voltage of the battery unit 222 has dropped below a predetermined threshold. In this embodiment, the battery unit 222 is charged to 95% of the maximum rated voltage, and the predetermined threshold is set to 70% of the maximum rated voltage. The charging circuit 221 includes a first comparator 2211 to detect whether the battery voltage has reached the predetermined threshold, and a second comparator 2213 to detect whether the battery voltage has reached the charging threshold, i.e. 95% of the maximum rated voltage. When the output of the first comparator 2211 indicates that the battery voltage has dropped below the predetermined threshold, the microprocessor 21 will activate the charging circuit 221 to initiate charging of the battery unit 222 by the primary power supply 30. When the output of the second comparator 2213 indicates that the battery voltage has reached the charging threshold, the microprocessor 21 will deactivate the charging circuit 221.

To prolong the service life of the rechargeable battery unit 222, the microprocessor 21 of the control unit 20 further enables periodic activation of the secondary lighting unit 24 when the light signal from the light sensor 23 indicates a bright ambient light condition so as to discharge the rechargeable battery unit 222. In this embodiment, the discharging cycle is set as one discharging operation per ten charging operations.

The alarm unit 27 is connected to and is controlled by the microprocessor 21 so as to generate an alarm signal upon detection by the microprocessor 21 that the rechargeable battery unit 222 is in a defective state, e.g. the battery voltage has dropped below a defective threshold. In this embodiment, the alarm unit 27 includes a buzzer 272 for generating an audible alarm output, and a drive transistor 271 for interconnecting the microprocessor 21 and the buzzer 272.

While the lighting apparatus of this embodiment is shown to be in the form of a ceiling lamp, it is apparent to those skilled in the art that the lighting apparatus of this invention may be implemented in the form of another lamp, such as a stand lamp.

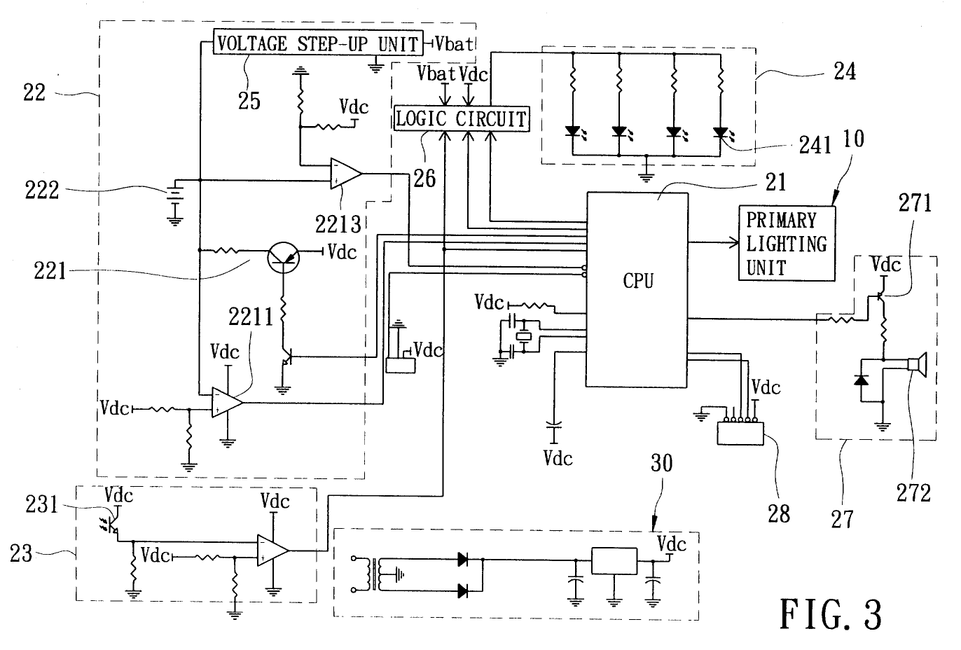

Preferably, as best shown in FIG. 3, a serial port 28 is connected to the microprocessor 21. In view of geographical and time zone differences in different parts of the world, the control operation of the lighting apparatus may require localization. The serial port 28 allows the user to connect the lighting apparatus to a computer (not shown) to establish control settings for the lighting apparatus.

It has thus been shown that the lighting apparatus of this invention combines the function and structure of a conventional lighting apparatus and emergency illumination equipment, thereby resulting in cost and space savings.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A lighting apparatus comprising:
a primary power supply adapted to be connected electrically to an electrical outlet;
a primary lighting unit connected to said primary power supply and including at least one high-power lamp;
a control unit connected to said primary power supply and said primary lighting unit and operable so as to control activation of said primary lighting unit;
a secondary lighting unit connected to said control unit and including at least one low-power high-intensity light source;
a light sensor connected to said control unit and generating a light signal corresponding to intensity of ambient light; and
a back-up power supply connected to said control unit;
said control unit enabling operation of said secondary lighting unit when said primary lighting unit is deactivated and the light signal from said light sensor indicates a poor ambient light condition;
said control unit further enabling supply of power from said back-up power supply to said secondary lighting unit to permit activation of said secondary lighting unit when power failure of said primary power supply occurs.

2. The lighting apparatus as claimed in claim 1, further comprising a remote controller operably associated with said control unit to control operation of said control unit.

3. The lighting apparatus as claimed in claim 1, wherein said control unit enables supply of power from said primary power supply to said secondary lighting unit when said primary lighting unit is deactivated, the light signal from said light sensor indicates a poor ambient light condition, and power failure of said primary power supply does not occur.

4. The lighting apparatus as claimed in claim 1, wherein said control unit includes a microprocessor and a logic circuit connected to said microprocessor, said microprocessor being responsible for controlling activation of said primary lighting unit, said logic circuit being responsible for controlling supply of power from one of said primary and back-up power supplies to said secondary lighting unit.

5. The lighting apparatus as claimed in claim 1, wherein said light source of said secondary lighting unit is a light emitting diode.

6. The lighting apparatus as claimed in claim 1, wherein said back-up power supply includes a rechargeable battery unit and a charging circuit connected to said rechargeable battery unit, said primary power supply and said control unit,
said charging circuit being activated by said control unit to initiate charging of said rechargeable battery unit by said primary power supply upon detection that a battery voltage of said rechargeable battery unit has dropped below a predetermined threshold.

7. The lighting apparatus as claimed in claim 6, wherein said back-up power supply further includes a voltage step-up unit connected to said rechargeable battery unit and said control unit, said voltage step-unit promoting the battery voltage to a level sufficient for driving said secondary lighting unit.

8. The lighting apparatus as claimed in claim 6, wherein said control unit further enables periodic activation of said secondary lighting unit when the light signal from said light sensor indicates a bright ambient light condition so as to discharge said rechargeable battery unit in order to prolong service life of said rechargeable battery unit.

9. The lighting apparatus as claimed in claim 6, further comprising an alarm unit connected to and controlled by said control unit so as to generate an alarm signal upon detection by said control unit that said rechargeable battery unit is in a defective state.

10. The lighting apparatus as claimed in claim 9, wherein said alarm unit includes a buzzer for generating an audible alarm output.

11. The lighting apparatus as claimed in claim 1, wherein said light sensor includes a phototransistor.
